(19) United States
(12) Patent Application Publication
(10) Pub. No.: US 2014/0320730 A1
(43) Pub. Date: Oct. 30, 2014

(54) METHOD FOR AUTOMATICALLY CONTROLLING FOCAL POINT OF DIGITAL OPTICAL DEVICE

(71) Applicant: Kyung-Wook Kim, Daegu (KR)

(72) Inventor: Kyung-Wook Kim, Daegu (KR)

(73) Assignee: TAE GEUK ELECTRIC GENERATION CO., LTD., Gumi-si (KR)

(21) Appl. No.: 14/119,277

(22) PCT Filed: Dec. 20, 2011
(86) PCT No.: PCT/KR2011/009859

§ 371 Date: Feb. 21, 2014

(51) Int. Cl. H04N 5/232

(52) U.S. Cl. CPC H04N 5/23212
USPC 348/345

(57) ABSTRACT

Disclosed is a method for automatically controlling a focal point of a digital optical device, which: performs the steps of a focal point mode for performing a high-speed AF operation, and function processing high-capacity function image data; configures a function mode for detecting function focal point data and comparing it to a critical range; automatically performs switching between the focal point mode and the function mode by using an optical device; yields high-capacity function image data having an adjusted focal point in an environment in which the optical device is used where focal point distances change rapidly when a subject or the user of the optical device is moving; and performs required commands at high speed through the optical device when the user of the storing optical device inputs a required command once.

### TECHNICAL FIELD

The present invention relates to a method of automatically controlling a focal point of a digital optical device and, more particularly, to a method of automatically controlling a focal point of a digital optical device wherein, in a state or environment in which the optical device is normally used, in a state in which a subject or a user of the optical device moved, and in an optical device use environment in which the focal point of the subject is abruptly changed, a processor unit of the optical device automatically monitors a focal point value according to the movement state and the abruptly changed environment and perform an auto focus (AF) operation at high speed to secure a focal point position of a lens, resets a critical range necessary to correspond to the movement state and the abruptly changed environment based on focal point information of a current subject, when the focal point information of the current subject is within the reset critical range and thus the user of the optical device inputs a function processing command, the AF operation is performed within the critical range according to the requested function processing command such that the AF operation is performed at high speed and, therefore, the processor unit rapidly performs the function processing step according to the function processing command requested by the user of the optical device, thereby reading and recording high-capacity image data.

### BACKGROUND ART

In general, a digital optical device, such as a mobile phone or a smart phone, using a small-sized camera module adopts a mode of high pass filter processing or sharpness function processing image data, setting a result value as a focal point value, and performing an AF operation based on the focal point value to acquire image data, the focal point of which has been adjusted.

The process of acquiring the image data, the focal point of which has been adjusted, is performed in the digital optical device as follows. An AF operation to secure the optimum focal point position of the lens is performed through a lens shift process of a user of the optical device performing the AF operation by pushing a shutter button half way down when image data are output through an image sensor unit and shifting a lens on a per unit step basis, a process of acquiring image data per unit step of the lens, a process of HPF processing or sharpness function processing the acquired image data, a process of detecting a focal point value, and a process of applying a searching algorithm to detect shift of the lens on the per unit step basis and the optimum focal point value using the detected focal point value. Upon completion of the AF operation, the user of the optical device fully pushes the shutter button to acquire and record image data, the focal point of which has been adjusted.

In the AF mode for securing the focal point position of the lens by pushing the shutter button half way down, however, it is necessary for the user of the optical device to input an additional execution command for pushing the shutter button half way down. As a result, during a preview function operation showing image data before the shutter button is pushed half way down through a display unit as a picture, it is difficult to show the picture, the focal point of which has been adjusted.

In addition, when a subject or the user of the optical device moves during the AF operation, the focal distance between the subject and the digital optical device is changed in proportion to the movement speed. In a case in which the AF operation speed is lower than the movement speed, therefore, it is difficult to perform the AF operation.

Furthermore, when the subject or the user of the optical device moves in a state in which the focal point position of the lens is secured after the AF operation is completed, the image data, the focal point of which has been adjusted by pushing the shutter button half way down, may be acquired and recorded as image data, the focal point of which has not been adjusted, when the shutter button is pushed fully.

### DISCLOSURE

### Technical Problem

The present invention has been made in view of the above problems and it is an object of the present invention to provide a method of automatically controlling a focal point of a digital optical device that is capable of enabling a processor unit of the optical device to automatically perform a preview function operation at high speed in a state in which a focal point is adjusted and a user of the optical device to acquire and store image data, the focal point of which has been adjusted, by pushing a shutter button without pushing the shutter button half way down while viewing a picture acquired through preview function processing through a display unit.

### Technical Solution

In accordance with the present invention, a method of automatically controlling a focal point of a digital optical device includes an auto focus (AF) step of detecting a focal point value of focusing image data output from an image sensor unit while shifting a lens on a per unit section basis in a focal point mode and securing an optimum focal point position of the lens having an optimum focal point value through the detected focal point values, a critical range resetting step of detecting a focal point value of function image data initially output from the image sensor unit after a mode is switched from the focal point mode to a function mode and resetting a critical range based on the detected focal point value as a reference value, a focal point value detection step of detecting a focal point value of function image data output from the image sensor unit in the function mode, and a verification step of comparing the focal point value detected at the focal point value detection step with the critical range reset at the critical range resetting step, retaining the function mode when the focal point value is within the critical range, and performing switching from the function mode to the focal point mode and re-performing the AF step and the critical range resetting step when the focal point value deviates from the critical range.

The AF step may include performing an AF operation through a deviation type searching algorithm for detecting the focal point value of the focusing image data output from the image sensor unit per section while an actuator of a focal point adjustment unit shifting the lens on the per unit section basis within a stroke range and securing the optimum focal point position of the lens having the optimum focal point value based on conditions comprising variations between a focal point value detected at a previous section and a focal point value detected at a current section and an error range therebetween.

At the AF step, only a portion of the pixel area of an image sensor may be activated using a sub sampling method, an AF window method, or an addressing pixel area designation method to convert the focusing image data acquired through the image sensor unit into low-capacity focusing image data, from which a focal point value may be detected.

### Advantageous Effects

As previously described, the present invention provides a method of automatically controlling a focal point of a digital optical device that is capable of performing an operation in a focal point mode of performing a high-speed AF operation for low-capacity focusing image data and a function mode of function processing initially output high-capacity function image data according to a function requested by a user after the focal point mode is executed, reflecting an offset value per requested function based on a function focal point value to reset a critical range, function processing the output high-capacity function image data, detecting a function focal point value, and comparing the detected function focal point value with the critical range and enabling a processor unit of the optical device to automatically perform a preview function operation at high speed in a state in which a focal point is adjusted and a user of the optical device to acquire and store image data, the focal point of which has been adjusted, by pushing a shutter button without pushing the shutter button half way down while viewing a picture acquired through preview function processing through a display unit.

In the present invention, therefore, during the preview function operation of the optical device, the processor unit of the optical device provides high-capacity function image data, the focal point of which has been automatically adjusted, such that the user of the optical device can view the high-capacity function image data as a picture.

In addition, in the present invention, the high-speed AF operation is performed through the focal point mode and the critical range is set. In a state in which a subject or the user of the optical device moved and in an optical device use environment in which the focal point value is abruptly changed, therefore, it is possible to perform the high-speed AF operation and a process of function processing the function image data, the focal point of which has been adjusted to a predetermined level or higher.

Furthermore, when the user of the optical device inputs a command for requesting another function in the preview function, the optimum focal point value of the function, the focal point of which has been adjusted, is within the critical range of the preview function. Consequently, it is possible to perform the AF operation of securing the optimum focal point position of the lens of the function requested at the current position of the lens in the preview function at high speed and, therefore, it is also possible to performing function processing of the requested function image data at high speed.

### BRIEF DESCRIPTION OF DRAWINGS

FIG. 1 is a block diagram showing components of a digital optical device to which a method of automatically controlling a focal point of the digital optical device according to the present invention may be applied;

FIGS. 2 and 3 are views showing a searching algorithm for a process of securing the optimum focal point position of a lens having the optimum focal point value using a focal point value for focusing in a focal point mode in the method of automatically controlling the focal point of the digital optical device according to the present invention;

FIG. 4 is a view showing configuration of a program to which the method of automatically controlling the focal point of the digital optical device according to the present invention is applied and sequentially showing a processing process of a processor unit; and

FIG. 5 is a view showing the structure of an image frame output from an image sensor unit and an arrangement state of a focal point mode and a function mode according to the method of automatically controlling the focal point of the digital optical device according to the present invention.

### BEST MODE

Hereinafter, a method of automatically controlling a focal point of a digital optical device according to the present invention will be described in detail with reference to the accompanying drawings.

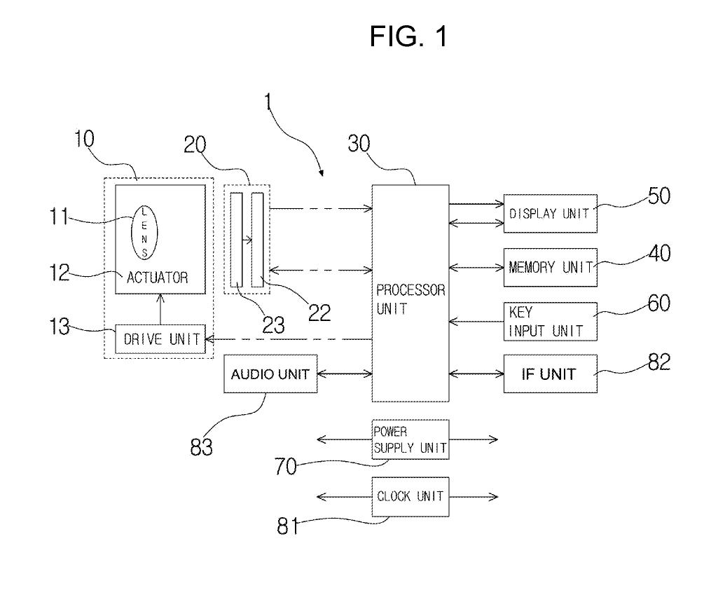

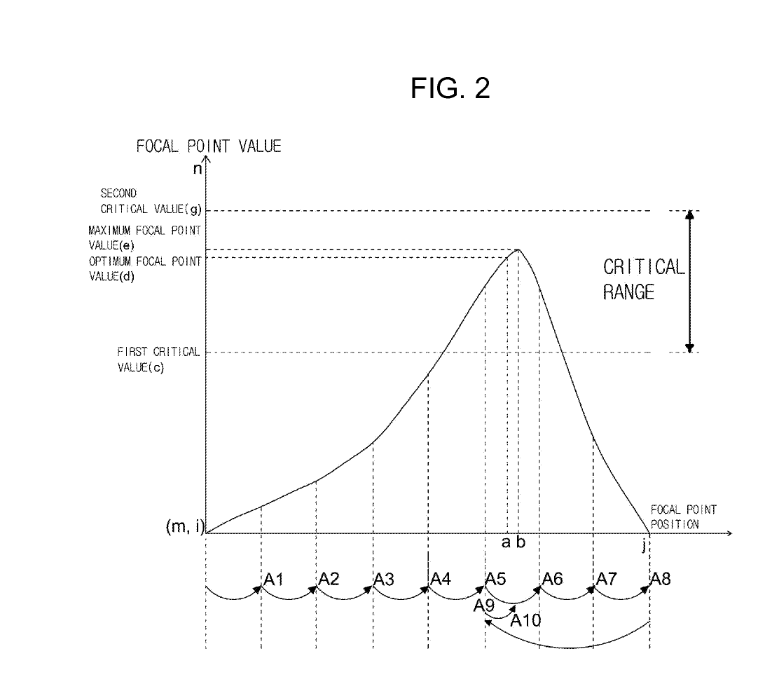

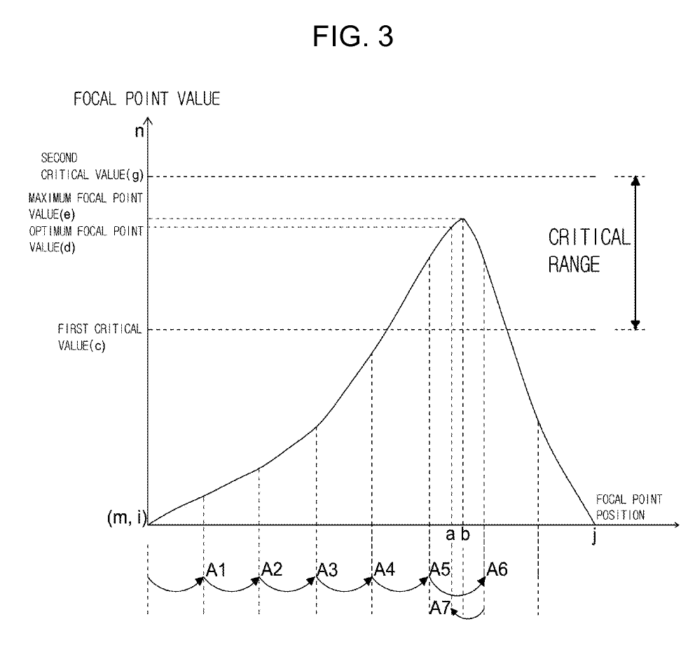

FIG. 1 is a block diagram showing components of a digital optical device to which a method of automatically controlling a focal point of the digital optical device according to the present invention may be applied and FIGS. 2 and 3 are views showing a searching algorithm for a process of securing the optimum focal point position of a lens having the optimum focal point value using a focal point value for focusing in a focal point mode in the method of automatically controlling the focal point of the digital optical device according to the present invention.

As shown in FIG. 1, a digital optical device 1 embodying the present invention basically includes a focal point adjustment unit 10 for moving a lens 11 forward and backward through a thrust generated by an actuator 12 using power applied by a drive unit 13 to secure a focal point position of the lens, an image sensor unit 20 consisting of an image sensor 23, having typically arranged RGB pixels, for converting an optical image generated as a result of passing through the lens 11 into an electric image signal and an image signal processor (ISP) 22 for converting the electric image signal generated by the image sensor 23 into Bayer, digital RGB, Ycbcr, or Yuv format image data (hereinafter, referred to as image data) and for performing an image data processing process including compensation, enhancement, and correction or adjustment to output the electric image and the image data while having optimum quality, a memory unit 40 for storing various kinds of data including image data and various kinds of codes including a program code, a power supply unit 70 for supplying power to the components, a clock unit 81 for providing a synchronization signal source, and a processor unit 50 for processing the various kinds of data including image data and various kinds of codes including a program code according to a program.

In addition, the digital optical device may further selectively include: a key input unit 60, including a key and a touchscreen, for allowing a user of the optical device to directly input an execution command, a display unit 50 for displaying image data as a picture, an IF unit 82 for providing a transmission route of data and codes to an external device, and an audio unit 83 including a microphone, a speaker, an ADC, a DAC, and an amplifier.

Meanwhile, as the result of development of an embedded semiconductor technology and a high-function processor technology, the components, such as the image sensor, the image signal processor, and the processor unit, of the optical device may be selectively combined to constitute a single semiconductor IC and an image data processing block performing an image data processing process including compensation, enhancement, and correction or adjustment or a processing method of the same to output image data while having optimum quality may be constituted as a module, which may be arranged at an appropriate position in the image data processing process.

In the image data processing process, it may be difficult to differentiate between the image signal processor 22 and the processor unit 30 in terms of function and configuration. Hereinafter, therefore, the image signal processor 22 and the processor unit 30 will be referred to as a processor unit and the image sensor unit 20 and the image sensor 23 will be referred to as an image sensor unit.

In the image data output from the image sensor unit 20, the entirety or half of an active pixel area is activated according to a value set by the processor unit. Consequently, an optical image having passed through the lens is converted into an electric image signal at the activated entire or half pixel area and the electric image signal is output as high-capacity image data (hereinafter, referred to as function image data) through the image data processing process. Alternatively, a sub sampling mode for activating a portion of the active pixel area, an AF window mode, or an addressing pixel area designation mode is applied. In this case, an optical image having passed through the lens is converted into an electric image signal at the activated portion of the pixel area and the electric image signal is output as low-capacity image data (hereinafter, referred to as focusing image data) through the image data processing process.

The function image data mean image data output from the image sensor unit when a function mode operation is performed and the focusing image data mean image data output from the image sensor unit when a focal point mode operation is performed. The present invention is characterized in that the data capacity of the focusing image data is smaller than the data capacity of the function image data and time for which the focusing image data are processed by the processor unit is shorter than time for which the function image data are processed by the processor unit.

In the digital optical device 1 configured as described above, when a user of the optical device generally inputs an optical device driving or function command through the key input unit 60, the processor unit 30 activates the respective components and sets initial values of the respective components according to a program stored in the memory unit 40.

Subsequently, the image sensor unit 20 converts an optical image having passed through the lens 11 of the focal point adjustment unit 10 into an electric image signal, configures function image frames including function image data B and a function guard or vertical blanking area A through the image data processing process, and outputs the function image frames per time difference. The processor unit 30 perform a preview function processing process including down scale, formatting, flip, and mirror with respect to the image data B of the image frames per time difference such that the user of the optical device may view an optical image of a subject having passed through the lens as a picture through the display unit 50.

When the user of the optical device requests the optical device to perform still image capturing function processing through the key input unit 60 while viewing the optical image of the subject having passed through the lens as the picture through the display unit, the processor unit 30 receives still image capturing function image data from the image sensor unit and performs a still image capturing function processing process through a still image compressor including J-PEG to convert the still image capturing function image data into still image compression data, which are stored in the memory unit 40.

In addition, when the user of the optical device requests the optical device to perform moving image recording function processing through the key input unit 60 while viewing the optical image of the subject having passed through the lens as the picture through the display unit, the processor unit 30 receives moving image recording function image data from the image sensor unit, receives audio data from the audio unit 83, and performs a moving image recording function processing process through a moving image compressor including M-PEG or H.264 for compressing a moving image to convert the moving image recording function image data into moving image compression data, which are stored in the memory unit 40.

In addition, when the user of the optical device requests the optical device to perform image recognition function processing through the key input unit 60 while viewing the optical image of the subject having passed through the lens as the picture through the display unit, the processor unit 30 receives data stored in the memory unit 40 and image recognition function image data output through the image sensor unit 20, performs an image recognition function processing process to generate a result value, and converts this result value into an image recognition function output format, which is output through the display unit 50 or stored in the memory unit 40.

In addition, data including text or fonts may be incorporated into the function image data including the preview, still image capturing, moving image recording, and image recognition function image data to generate new image data, which may be output through the display unit 50 or stored in the memory unit 40.

Meanwhile, as shown in FIGS. 2 to 5, the method of automatically controlling the focal point of the digital optical device according to the present invention applied to the digital optical device 1 as described above may include a focal point mode, a function mode, a focal point value detection step, and a critical range resetting step.

In the focal point mode, an auto focus (AF) operation for securing the optimum focal point position of the lens having the optimum focal point value using focusing image data is performed. In the function mode, the processor unit sets values to output respective function image data to the image sensor unit according to a function (preview function, still image capturing function, moving image recording function, or image recognition function) request command input by the user of the optical device, the image sensor unit outputs the requested function image data per function, and the processor unit performs the requested function processing process per function using the function image data.

At the critical range resetting step, the processor unit detects a function focal point value of the function image data initially output from the image sensor unit after execution of the focal point mode is completed, calculates a critical range by reflecting an offset value designated per function based on the detected focal point value, and resets the calculated critical range by substituting the calculated critical range into a designated critical range variable.

In the auto focus (AF) operation of the lens through the focal point mode, the lens is shifted on a per unit section basis, the image sensor unit 20 outputs focusing image data at each unit section to which the lens has been shifted and high pass filter (HPF) processes the output focusing image data to extract an edge component value or sharpness function processes the output focusing image data to acquire a result value (hereinafter, referred to as a focal point value) as a focal point value. The processor unit secures the optimum focal point position of the lens having the optimum focal point value through a programmed searching algorithm using the focal point value per unit section.

A description will be given of a searching algorithm process for securing the optimum focal point position of the lens having the optimum focal point value using unit shift of the lens and the focusing focal point value detected from the focusing image data of the image sensor unit output per unit section of the shift of the lens in the focal point mode in the method of automatically controlling the focal point of the digital optical device according to the present invention as described above with reference to FIGS. 2 and 3.

In FIGS. 2 and 3, the vertical axis (y axis) indicates a focal point value. The optimum focal point value is between the minimum value m and the maximum value n of the focal point value. The horizontal axis (x axis) indicates a distance between an RGB sensor surface constituting the image sensor 22 and the lens (hereinafter, referred to as a focal point position). In the drawings, the optimum focal point position of the lens is between the minimum value i and the maximum value j of the focal point position (hereinafter, referred to as a lens stroke range).

In addition, a curve in each drawing is a characteristic curve illustrating change of a focal point value per focal point position. In the illustrated characteristic curve, a focal point value e intersecting a focal point position b is the maximum focal point value and a focal point value d intersecting the optimum focal point position a is the optimum focal point value.

Although the optical device is in the most ideal auto focus (AF) state when the maximum focal point value e is the optimum focal point value d, the focal point position of the lens is secured at the optimum focal point position a intersecting the optimum focal point value d present within an error range of the maximum focal point value e according to optical device design conditions including a driving error of the actuator and auto focus (AF) time and then the auto focus (AF) operation is completed.

In this specification, therefore, the maximum focal point value e and the optimum focal point value d are referred to as “the optimum focal point value” without differentiation between the maximum focal point value e and the optimum focal point value d and the position of the lens at the optimum focal point position a where function image data having the optimum focal point value can be acquired is referred to as “the optimum focal point position”.

FIG. 2 illustrates an auto focus operation performed through a full scan type searching algorithm in which the lens is sequentially shifted on a per unit section basis A1, A2, A3, . . . , and A8 within the lens stroke range through the actuator 12 of the focal point adjustment unit 10, a focal point value is extracted at each unit section, an appropriate focal point value designated by the program is found from among the extracted focal point values, the lens is shifted to a position A9 having the appropriate focal point value, each unit section of the lens is subdivided, and the lens is shifted to a unit section A10 to secure the optimum focal point position A10 of the lens having the optimum focal point value.

FIG. 3 showing another embodiment illustrates an auto focus operation performed through a deviation type searching algorithm in which the lens is sequentially shifted on a per unit section basis, a focal point value is extracted, when the focal point value at the previous section is less than the focal point value at the current section and deviates from an error range, the lens is shifted on a per unit section basis A1, A2, . . . , and A5 in the forward direction, when the focal point value at the previous section is greater than the focal point value at the current section and deviates from the error range, each unit section of the lens is subdivided in the reverse direction, the lens is shifted per a unit section A6, and, when the focal point value at the previous section is equal to the focal point value at the current section or is within the error range, the lens is fixed at the current position A7 to secure the optimum focal point position A7 of the lens having the optimum focal point value.

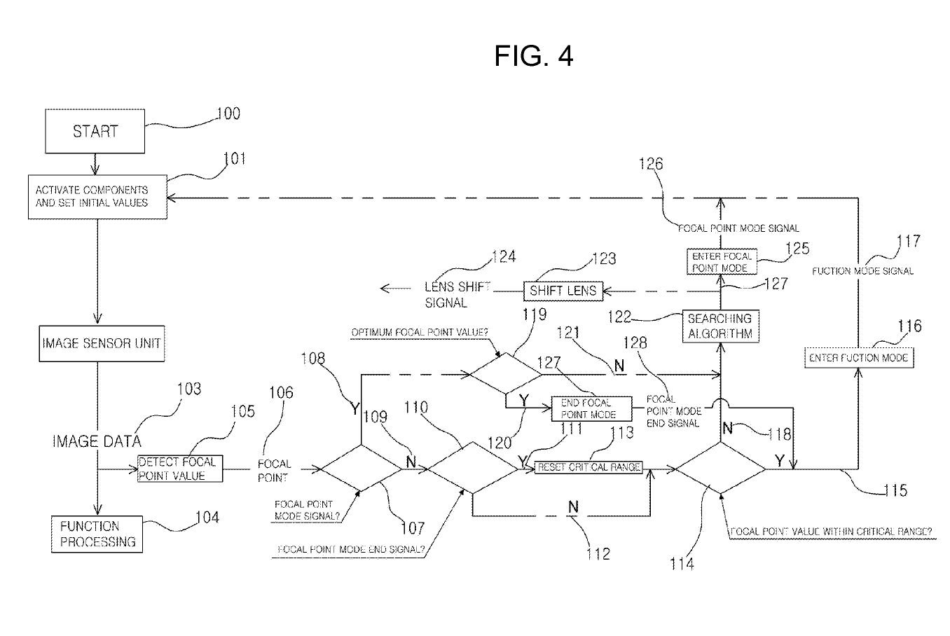

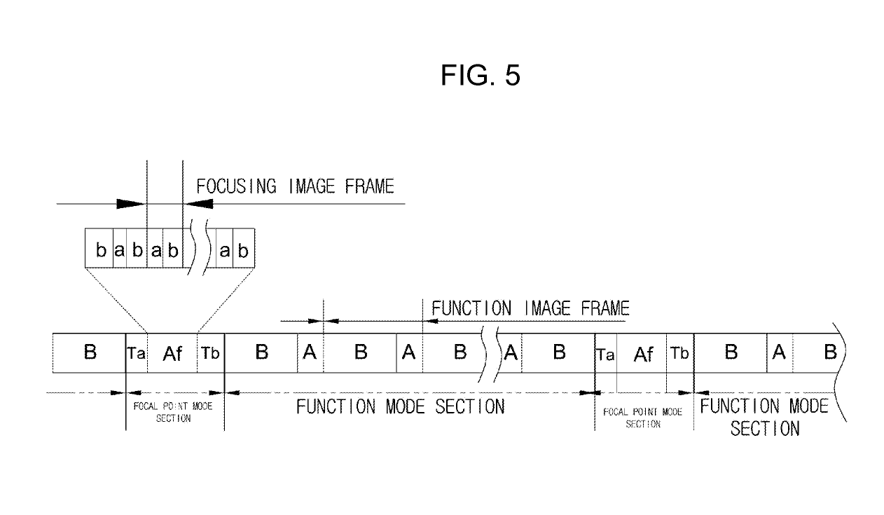

FIG. 4 is a view showing configuration of a program to which the method of automatically controlling the focal point of the digital optical device according to the present invention is applied and sequentially showing a processing process of a processor unit and FIG. 5 is a view showing the structure of an image frame output from an image sensor unit according to the method of automatically controlling the focal point of the digital optical device according to the present invention and an arrangement state of a focal point mode or a function mode.

As shown in FIG. 4, the configuration of the program of the optical device embodying the present invention is applied and the processing process of the processor unit include a first condition sentence 107 for differentiatedly designating a focal point mode retention route 108 and a focal point mode deviation route 109 according to a focal point mode signal 126, a second condition sentence 110 for differentiatedly designating a route 113 for resetting a critical range to a critical range variable of a third condition sentence and a route 112 for applying a predetermined critical range according to a focal point mode end signal 128, a third condition sentence 114 for differentiatedly designating a function mode route 115 and a focal point mode route 118 based on determination as to whether a function focal point value 106 detected from function image data 103 output from the image sensor unit is within the critical range, and a fourth condition sentence 119 for differentiatedly designating a focal point mode end route 120 and a focal point mode retention route 121 based on determination as to whether a focusing focal point value 106 detected from focusing image data 103 output from the image sensor unit is the optimum focal point value suitable for a condition designated by a searching algorithm 122.

At a focal point mode entry step (125), a value for the image sensor unit to output focusing image data is set and a focal point mode signal 126 for activating the focal point mode retention route 108 of the first condition sentence is output.

At a function mode entry step (116), a value for the image sensor unit to output requested function image data 103 designated per function according to a function request command input by a user of the optical device through the key input unit is set and a function mode signal 117 is output.

At a focal point value detection step (105), the image data 103 output from the image sensor unit is processed through the high pass filter (HPF) or sharpness function processed to detect and output input values of the third condition sentence and the fourth condition sentence and a focal point value 106 serving as a reference value at a critical range resetting step (113).

At the critical range resetting step (113), a focal point mode is ended (127), entry into a function mode is performed (116), the function focal point value 106 detected (105) from initial function image data 103 output from the image sensor unit is used and an upper or lower offset value is applied to calculate a first critical value and a second critical value and a range therebetween as a critical range, and the critical range is substituted into the critical range variable of the third condition sentence 114 to reset the critical range.

At the focal point mode end step (127), when the determination result of the fourth condition sentence indicates that the focusing focal point value is the optimum focal point value, a focal point mode closed loop is ended (120), the critical range resetting route 111 of the second condition sentence is activated, and a focal point mode end signal 128 for entry into the function mode (116) is output.

At a searching algorithm step (122), which is a step of performing a searching algorithm for detecting the optimum focal point position of the lens having the optimum focal point value, a control value equivalent to a unit shift distance of the lens designated by the applied searching algorithm is provided to a lens shift step (123), condition values including an error range and operation start time are set in the fourth condition sentence for securing the optimum focal point value, and a focal point mode entry signal 127 for entry into the focal point mode (125) is output.

At the lens shift step (123), a lens shift signal 124 for controlling the drive unit 13 supplying driving power to the actuator 12 providing a thrust necessary to shift and stop the lens 11 is output.

At a function processing step (104), a function requested by the user of the optical device is executed with respect to the image data output from the image sensor unit.

Hereinafter, a description will be given of a preview function processing process, to which the method of automatically controlling the focal point of the digital optical device according to the present invention is applied.

When the user of the digital optical device inputs an optical device driving start command 100 through the key input unit 60, the power supply unit and the clock unit are activated. According to the program stored in the memory, the processor unit 30 activates the respective components, including the image sensor unit 20, and sets initial values of the respective components.

Subsequently, according to the set initial values (101), the image sensor unit outputs an optical image having passed through the lens as preview function image data 103, and the processor unit performs the preview function processing step (104) of converting the preview function image data into an image suitable for the display unit and, in addition, performs the focal point value detection step (105) to output a function focal point value (106). Since the focal point mode signal 126 and the focal point mode end signal 128 have not been output, the processor unit determines whether the function focal point value is within a predetermined critical range at the initial value setting step (101).

For example, in a case in which the function focal point value is within the critical range, the processor unit performs the function mode entry step (116) to set a value for the image sensor unit to output the designated preview function image data and outputs a function mode signal 117. The image sensor unit outputs preview function image data 103. The processor unit performs the preview function processing step (104) with respect to the output preview function image data and, in addition, performs the focal point value detection step (105) to output a function focal point value (106).

On the other hand, in a case in which the function focal point value deviates from the critical range, the processor unit enters the focal point mode (118), performs the searching algorithm step (122) to shift the lens on a per unit section basis, sets a condition value of the fourth condition sentence 119, outputs a focal point mode entry signal 127, performs the focal point mode entry step (125) to set a value for the image sensor unit to output focusing image data 103 and outputs a focal point mode signal 126. The image sensor unit outputs the focusing image data 103, performs the focal point value detection step (105) to output a focusing focal point value (106), and executes the fourth condition sentence according to the focal point mode signal 126 to repeatedly perform a focal point mode closed loop operation for determining whether the focusing focal point value is the optimum focal point value until the focusing focal point value becomes the optimum focal point value.

Subsequently, when the focusing focal point value becomes the optimum focal point value, which means that the optimum focal point position of the lens is secured through the focal point mode, the focal point mode end step (127) is performed to output a focal point mode end signal 128, the function mode entry step (116) is performed to set a value for the image sensor unit to output the designated preview function image data, and a function mode signal 117 is output. The image sensor unit outputs initial preview function image data 103, the focal point of which has been adjusted (the focal point mode of which has been ended or the AF step of which has been ended). The processor unit performs the preview function processing step (104) with respect to the initial preview function image data, the focal point of which has been adjusted, and, in addition, performs the focal point value detection step (105) to output a function focal point value (106).

In addition, the critical range resetting step (113) is performed according to the focal point mode end signal 128 to reflect an offset value having the function focal point value of the initial preview function image data, the focal point of which has been adjusted, as a reference value to calculate a critical range, including a first critical value and a second critical value, the calculated critical range is substituted into a critical range variable of the third condition sentence to reset the critical range, the third condition sentence is executed such that the function focal point value is within the critical range, the function mode entry step (116) is performed to set a value for the image sensor unit to output the designated preview function image data, and a function mode signal 117 is output. The image sensor unit outputs the preview function image data 103. The processor unit performs the preview function processing step (104) and, in addition, performs the focal point value detection step (105) to output a function focal point value (106). Since the focal point mode end signal 128 and the focal point mode signal 126 have not been supplied, the processor unit executes the third condition sentence 114 to determine whether the input function focal point value is within the predetermined critical range.

For example, in a case in which the function focal point value is within the predetermined critical range, entry into the function mode is performed. The image sensor unit outputs the preview function image data and the processor unit performs the preview function processing step. In addition, the processor unit detects a function focal point value and repeatedly performs a function mode closed loop for determining whether the function focal point value is within the reset critical range.

On the other hand, in a case in which the function focal point value deviates from the predetermined critical range, switching to the focal point mode is automatically performed. According to the searching algorithm 122, the lens is shifted on a per unit section basis and a focal point mode closed loop is repeatedly performed until the focusing focal point value becomes the optimum focal point value.

Subsequently, when the focusing focal point value becomes the optimum focal point value, the focal point mode is ended and the preview function processing step is performed with respect to the initial preview function image data, the focal point of which has been adjusted. In addition, a function focal point value is detected and the critical range resetting step is performed to reset the critical range having the detected function focal point value as a reference value. Subsequently, the function mode closed loop is repeatedly performed until the function focal point value deviates from the reset critical range

Meanwhile, the user of the optical device may request processing of a specific one among various functions including still image capturing, moving image recording, and image recognition through the key input unit while viewing the preview function as a picture.

Hereinafter, a switching process between the preview function and the requested function, to which the method of automatically controlling the focal point of the digital optical device according to the present invention is applied, and a function processing process after switching in which the processor unit of the optical device performs processing of the requested function will be described.

The user of the optical device inputs a specific function processing request command to the processor unit of the optical device repeatedly performing the focal point mode operation and the function mode operation while having the critical range as the condition value through the key input unit while viewing the preview function as a picture regardless of an operation start time per mode and the processor unit executes the requested function.

For example, in a case in which the requested function processing command is input at the focal point mode, the processor unit performs the current focal point mode and then performs the function mode entry step (116) to set a value for the image sensor unit to output the requested function image data and outputs a function mode signal. The image sensor unit outputs the requested function image data. The processor unit performs the requested function processing step with respect to the requested initial function image data. In addition, the processor unit performs the focal point value detection step (105) to output a function focal point value, calculates a critical range, including a first critical value and a second critical value, by reflecting an offset value of the requested function based on the function focal point value as a reference value, and resets the critical range by substituting the calculated critical range into a critical range variable of the third condition sentence.

On the other hand, in a case in which the requested function processing command is input at the function mode, the processor unit calculates a critical range, including a first critical value and a second critical value, by reflecting an offset value of the requested function based on the function focal point value of the initial preview function image data, the focal point mode of which has been completed, which was a reference value for resetting the current critical range, as a reference value and resets the critical range by substituting the calculated critical range into a critical range variable of the third condition sentence. In addition, the processor unit receives preview function image data of the current function mode and performs the preview function processing step (104) with respect to the input preview function image data, performs the focal point value detection step (105) to output a function focal point value, and executes the third condition sentence to compare the detected function focal point value with the reset critical range.

For example, in a case in which the detected function focal point value is within the reset critical range, the processor unit performs the function mode entry step (116) to set a value for the image sensor unit to output the requested function image data and outputs a function mode signal 117. The image sensor unit outputs the requested function image data. The processor unit performs the requested function processing step (104) with respect to the requested function image data and, in addition, performs the focal point value detection step (105).

On the other hand, in a case in which the detected function focal point value deviates from the reset critical range, the processor unit performs the searching algorithm step (122), repeatedly performs the focal point mode closed loop to secure the optimum focal point position of the lens having the focusing focal point value of the focusing image data output from the image sensor unit as the optimum focal point value, performs the focal point mode end step (127) to output a focal point mode end signal 128, performs the function mode entry step (116) to set a value for the image sensor unit to output the requested function image data, and outputs a function mode signal. The image sensor unit outputs the requested initial function image data. The processor unit performs the requested function processing step (104) with respect to the requested function image data. In addition, the processor unit detects a function focal point value and performs the critical range resetting step to reset the critical range.

Subsequently, a process of processing the requested function which needs a plurality of function image data, such as a moving image recording function, a multiple shot capturing function, or an image recognition function using a plurality of image data, is performed in the same manner as in the preview function processing process. The requested function is ended through the key input unit or automatically ended according to the program.

On the other hand, a process of processing the requested function which needs one piece of function image data, such as a single shot capturing function or an image recognition function using one piece of function image data, is performed as follows. The focal point mode is ended, and the function mode entry step is performed to set a value for the image sensor unit to output the requested function image data and outputs a function mode signal. The image sensor unit outputs the requested function image data. The processor unit performs the requested function processing step and then ends the requested function.

When the requested function is ended, switching to the preview function may be automatically performed according to the program or the optical device may enter a sleep state or a power off state.

The structure of an image frame output from the image sensor unit in the preview function processing process of the method of automatically controlling the focal point of the digital optical device according to the present invention and an arrangement state of the focal point mode or the function mode are shown in FIG. 5.

A function image frame includes a function image data time area B, which is a time area occupied by the function image data output from the image sensor unit, and a guard or vertical blanking area A, which is a time area at which the processor unit sets a value, including auto expose (AE), auto white balance (AWB), compensation, enhancement, or correction or adjustment, for the image sensor unit 20 to analyze the previous function image data and to receive the optimized next function image data. A function mode section includes function image frames successively arranged with time differences. In the function mode section, the processor unit performs a function mode operation including a critical range resetting step.

A focal point mode section includes a focal point mode switching time area Ta, which is a time area necessary for switching from the function mode to the focal point mode, an auto focus time area Af at which focusing image frames successively arranged with time differences to perform a focal point mode operation, and a function mode switching time area Tb, which is a time area necessary for switching from the focal point mode to the function mode. The auto focus time area Af includes focusing image frames. Each of the focusing image frames includes a focusing image data area b and a focusing guard or vertical blanking area a. In the focal point mode section, the processor unit performs a focal point mode operation and a switching operation between the modes.

At the auto focus time area Af of the focal point mode section, a high-speed auto focus (AF) operation of shifting the lens on a per unit section basis according to the searching algorithm, the image sensor unit outputting focusing image data b per unit section to which the lens is shifted, detecting focal point values, and securing the optimum focal point position of the lens having the optimum focal point values based on the detected focal point values is performed.

Meanwhile, when the focal point mode section requires excessive time, image data included during the focal point mode operation may be out of focus. Furthermore, when a subject or the user of the optical device moves, the focal distance is changed in proportion to the movement speed. In a case in which the auto focus (AF) operation speed is lower than the movement speed, therefore, it may be difficult to perform the auto focus (AF) operation. The present invention is characterized in that a method of minimizing the focal point mode section is applied.

According to the present invention, the method of minimizing the focal point mode section is performed as follows. In order to minimize the focal point mode switching time Ta and the function mode switching time Tb, a one time processing (OTP) memory of the image sensor unit 20 is utilized. A focal point mode switching area is configured in the OTP memory and a program necessary for focal point mode switching or a switching value including set values is stored in the configured focal point mode switching area.

In addition, a function mode switching area is configured in the OTP memory and a program necessary for function mode switching or a switching value including set values is stored in the configured function mode switching area. When the mode is switched from the function mode to the focal point mode, the processor unit requests the image sensor unit to activate the focal point mode switching area of the OTP memory and the image sensor unit performs switching to the focal point mode to output focusing image data.

When the mode is switched from the focal point mode to the function mode, the processor unit requests the image sensor unit to activate the function mode switching area of the OTP memory and the image sensor unit performs switching to the function mode to output function image data. As a result, the focal point mode switching time Ta and the function mode switching time Tb are minimized.

In the focusing image data time area b, the entire active pixel area of the image sensor unit 20 is not activated but a portion of the pixel area is activated using a sub sampling mode, an AF window mode, or an addressing pixel area designation mode. Consequently, an optical image is converted into an electric image signal only at the activated portion of the pixel area and focusing image data are output. As a result, the focusing image data are low-capacity image data. As shown in FIG. 5, therefore, the focusing image data time area b may be shorter than the function image data time area B at which the entire or half active pixel area of the image sensor unit 20 is activated to constitute high-capacity image data.

In addition, the focusing guard or vertical blanking area a is a time area at which the processor unit 30 sets a value for the image sensor unit 20 to analyze the previous image data and to receive the optimized next function image data. The number of times for changing the set value may be reduced by partially equally applying the set value to the last set value of the function mode section before the focal point mode section, high-speed transmission technology may be applied to the code or data transmission route between the image sensor unit 20 and the processor unit 30, an actuator having rapid response time may be applied to increase unit section shift speed of the lens, a processing process may be optimized in a program for processing the focal point mode section, or the OTP memory may be applied. As shown in FIG. 5, therefore, it is possible to configure the focusing guard or vertical blanking area a such that the focusing guard or vertical blanking area a is shorter than the function guard or vertical blanking area.

In this way, the focal point mode switching time Ta, the focusing image data area b, and the focusing guard or vertical blanking area a may be shortened. As a result, the focal point mode section may be shortened.

As shown in FIG. 5, a plurality of focusing image frames may be arranged as compared with a time area of one function image frame. Consequently, it is possible to perform a high-speed auto focus (AF) operation through the focusing image frames having a reduced time range.

Meanwhile, as shown in FIGS. 2 and 3, the length of the time area of the focal point mode may be changed according to the searching algorithm applied to the auto focus time area Af of the focal point mode section and the optimum focal point position a of the lens having the optimum focal point value d in the stroke range and a time length difference is generated between the focal point mode sections. A synchronous mode for synchronizing in time with a function image frame or an asynchronous mode having no relation to a function image frame may be applied for the time length difference between the focal point mode sections.

In the synchronous mode, the time length of the focal point mode section may be configured to be the same as the time length of the function image frame or the time length of the focal point mode section may be configured to be an integer times longer than the time length of the function image frame.

In addition, in the synchronous mode, the focal point mode section having a shorter time length than the function image frame may be delayed in the focal point mode section such that the time length of the focal point mode section is synchronized to be equal to the time length of the function image frame, the time length of the focal point mode section having a longer time length than the function image frame may be extended by an integer times of the time length of the function image frame such that time length of the focal point mode section is synchronized to be equal to the time length of the function image frame, or the time length of the focal point mode section is set to the same as the time length of the function image frame and the focal point mode and the function mode may be repeatedly executed to secure the optimum focal point position of the lens.

In the asynchronous mode, when the auto focus (AF) operation for securing the optimum focal point position of the lens is completed in the focal point mode section irrespective of the difference in time length between the function image frame and the focal point mode, switching to the function mode Ta may be performed without time delay and the function image frame may be output.

Meanwhile, as shown in FIG. 5, in processing the preview function in which focal point mode sections having a periodicity are inserted between function image frames having periodicity or the moving image recording function, a method of processing the preview function of image data or the moving image recording function in the aperiodic focal point mode section may include the following methods.

A first method is a method of function processing all or some focusing image data b included in the focal point mode section as function image data.

A second method is a method of using focusing image data b included in the focal point mode section only to secure the optimum focal point position of the lens and function processing only function image data excluding the focal point mode section.

A third method is a method of extracting some of focusing image data b included in the focal point mode section, incorporating the extracted focusing image data into function image data before switching to the focal point mode to generate third function image data, and function processing the third function image data.

Meanwhile, the digital optical device, to which the present invention is applied, necessarily includes an image sensor unit and further includes additional components in addition to the image sensor unit.

A function processing request command of the processor unit of the optical device may be requested by the user of the optical device through the key input unit, may be requested based on a result sensed by an additional sensor unit, or may be requested according to a function request program in the optical device.

In addition, the algorithm for detecting the optimum focal point value, which is applied at the searching algorithm step, may be used as one selected from among various algorithms, including a deviation type algorithm or a scan type algorithm. Alternatively, the algorithm for detecting the optimum focal point value may be used as a combination of the algorithms selected from among various algorithms, including the deviation type algorithm and the scan type algorithm.

Therefore, the present invention is characterized in that the present invention adopts an auto focus (AF) mode for automatically setting the critical range and the processor unit of the optical device automatically performing the focal point mode operation only when the function focal point value of the function image data output through the image sensor unit deviates from the critical range to automatically secure the optimum focal point position of the lens having the optimum focal point value unlike an auto focus (AF) mode for securing the optimum focal point position of the lens having the optimum focal point value when the user of the optical device pushes a shutter button half way down through the key input unit 60 while viewing a preview function processed picture through the display unit 50.

In addition, the present invention is characterized in that, in an environment in which the optical device is used, the processor unit of the optical device automatically performs the auto focus operation when the subject or the user of the optical device moves and when the focal point value is abruptly changed, automatically performs entry into the function mode to detect a function focal point value of the initial function image data, and automatically resets the critical range based on the detected function focal point value as a reference value.

In addition, the present invention is characterized in that the critical range is not a fixed value but a value calculated by reflecting an offset value designated per function requested at the critical range resetting step based on a function focal point value detected at the focal point value detection step as a reference value and that the function focal point value as the reference value is changed according to environmental change of a subject and, therefore, the critical range is automatically changed according to environmental change of the subject.

In addition, in switching between the preview function and the function requested by the user of the optical device, the optimum focal point value of the requested function is within the critical range during the preview function operation and information regarding the size of the optimum focal point value and the optimum focal point position of the lens can be checked at the focal point value detection step. When the focal point mode is executed during operation of the requested function, therefore, it is possible to reduce the number of times of repetition of the focal point mode closed loop for securing the optimum focal point position of the lens.

Consequently, the present invention is characterized in that, when switching from the preview function to the function requested by the user of the optical device is performed or switching from the requested function to the preview function is performed, switching between the functions is performed at the position at which execution of the current function has been ended as the initial position of the lens and, therefore, switching between the preview function and the requested function and the function processing operation can be performed at high speed.

Meanwhile, in the present invention, when the focal point mode is executed, the shift start position of the lens is expressed as the initial position of the lens. When the user of the optical device initially drives the optical device and the optical device executes the focal point mode, the AF operation is performed at the initial distant view position (position i) as the initial position of the lens as shown in FIGS. 2 and 3.

Meanwhile, a second critical value may be fixedly set to the maximum value of the focal point value axis (Y axis) (the upper limit value n of the focal point value that can be detected from image data), a first critical value may be calculated by reflecting an offset value designated per function based on the function focal point value (the optimum focal point value) as a reference value, and a range between the maximum value n of the focal point value axis and the calculated first critical value as a critical range may be substituted into the critical range variable of the third condition sentence to reset the critical range.

In addition, a manufacturer of the optical device may set an offset value per function including preview, still image capturing, moving image recording, and image recognition and may store the set offset value in the memory unit. Alternatively, the user of the optical device may set an offset value per function through the key input unit and may store the set offset value in the memory unit. When each function is executed, therefore, the critical range may be calculated by reflecting the stored offset value based on the function focal point value as the reference value at the critical range resetting step and the calculated critical range may be substituted into the critical range variable to reset the critical range.

When the subject or the user of the optical device moves, when the subject is abruptly changed, and when switching between the preview function and the requested function is performed, the high-speed focal point mode is performed, the critical range is applied, the critical range is reset, the focal point mode closed loop is automatically performed, the function mode is automatically performed, and switching between the modes is automatically performed according to the method of automatically controlling the focal point of the digital optical device according to the present invention. After inputting a request command per function, including preview, still image capturing, moving image recording, and image recognition processing, therefore, it is possible for the user of the optical device to confirm that function image data of the requested function, the focal point of which has been adjusted, are acquired from the optical device and stored at high speed.

1. A method of automatically controlling a focal point of a digital optical device comprising:
an auto focus (AF) step of detecting a focal point value of focusing image data output from an image sensor unit while shifting a lens on a per unit section basis in a focal point mode and securing an optimum focal point position of the lens having an optimum focal point value through the detected focal point values;
a critical range resetting step of detecting a focal point value of function image data initially output from the image sensor unit after a mode is switched from the focal point mode to a function mode and resetting a critical range based on the detected focal point value as a reference value;
a focal point value detection step of detecting a focal point value of function image data output from the image sensor unit in the function mode; and
a verification step of comparing the focal point value detected at the focal point value detection step with the critical range reset at the critical range resetting step, retaining the function mode when the focal point value is within the critical range, and performing switching from the function mode to the focal point mode and re-performing the AF step and the critical range resetting step when the focal point value deviates from the critical range.

2. The method according to claim 1, wherein the critical range resetting step comprises calculating a critical range by reflecting a designated offset value based on the focal point value of the function image data initially output from the image sensor unit as the reference value at the optimum focal point position of the lens having the optimum focal point value through the focal point mode and resetting the critical range by substituting the calculated critical range into a designated critical range variable.

3. The method according to claim 1, wherein the AF step comprises securing the optimum focal point position of the lens through a deviation type searching algorithm for detecting the focal point value of the focusing image data output from the image sensor unit per section while an actuator of a focal point adjustment unit shifting the lens on the per unit section basis within a stroke range and securing the optimum focal point position of the lens having the optimum focal point value based on conditions comprising variations between a focal point value detected at a previous section and a focal point value detected at a current section and an error range therebetween.

4. The method according to claim 1, wherein, when switching from a preview function to a function requested by a user of the optical device is performed or switching from the requested function to the preview function is performed, a position at which execution of a previous function has been ended is set as an initial position of the lens and, when the switched function is executed in the focal point mode, an AF operation is performed based on the initial position of the lens as a start point.

5. The method according to claim 1, wherein the focusing image data acquired through the image sensor unit in the focal point mode are low-capacity image data having lower capacities than the function image data acquired through the image sensor unit in the function mode.

6. The method according to claim 1, wherein an offset value stored in a memory unit through user manipulation using a key input unit is applied as the offset value applied at the critical range resetting step.

7. The method according to claim 1, wherein, in the focal point mode and the function mode, a processor unit transmits a command for outputting designated image data to the image sensor unit using an one time process (OTP) memory of the image sensor unit.
